(19) United States
(12) Patent Application Publication
(10) Pub. No.: US 2026/0238560 A1
(43) Pub. Date: Aug. 13, 2026

(54) ANALYSING AND HANDLING TRAFFIC IN A COMMUNICATION NETWORK

(71) Applicant: Telefonaktiebolaget LM Ericsson (publ), Stockholm (SE)

(72) Inventors: Rodrigo ALVAREZ DOMINGUEZ, Madrid (ES); Miguel Angel MUÑOZ DE LA TORRE ALONSO, Madrid (ES)

(73) Assignee: Telefonaktiebolaget LM Ericsson (publ), Stockholm (SE)

(21) Appl. No.: 19/471,077

(22) PCT Filed: May 4, 2023
(86) PCT No.: PCT/EP2023/061750

§ 371 Date: Sep. 30, 2025

(30) Foreign Application Priority Data
Apr. 3, 2023 (EP) 23382321.0

(51) Int. Cl. H04L 41/16; H04L 51/043

(52) U.S. Cl. CPC H04L 41/16; H04L 51/043

(57) ABSTRACT

There is provided a method performed by an analytics node in a communication network, the method comprising: obtaining (401), from a user plane network node in the communication network, flow information relating to user data traffic conveyed by the user plane network node for one or more user equipments, UEs, in the communication network. The flow information comprises measurements of traffic flows on a per traffic flow basis. The method further comprises analysing (403) the obtained flow information using a trained machine learning, ML, model to generate an analytics report, wherein the analytics report relates to presence of spam content in the user data traffic.

### TECHNICAL FIELD

This disclosure relates to communication networks, and in particular to the identification of network traffic that is spam.

### BACKGROUND

In 5^{th} Generation (5G) cellular networks, a service-based architecture is used for the core network, which is broken down into communicating services known as Network Functions (NFs).

FIG. 1 illustrates part of a 5G system reference architecture 101 showing service-based interfaces used within the Control Plane (CP). It will be appreciated that not all types of NFs used in 5G are depicted. Service-based interfaces are represented in the format Nxyz and point to point interfaces in the format Nx. The reference architecture 101 shown in FIG. 1 comprises the following types of NF: a Unified Data Repository (UDR) 102 that has a Nudr interface, a Network Exposure Function (NEF) 103 that has a Nnef interface, a Network Data Analytics Function (NWDAF) 104 that has a Nnwdaf interface, an Application Function (AF) 105 that has a Naf interface, a Policy Control Function (PCF) 106 that has a Npcf interface, an Analytics Data Repository Function (ADRF) 107 that has a Nadrf interface, an Access and Mobility Management Function (AMF) 108 that has a Namf interface, and a Session Management Function (SMF) 109 that has a Nsmf interface. The SMF 109 has an N4 interface to a User Plane Function (UPF) 110.

Although not shown in FIG. 1, the AMF 108 has an N1 interface to a user equipment (UE), and an N2 interface to an access network (AN), which can be a radio access network (RAN).

The UDR 102 stores data grouped into distinct collections of subscription-related information, such as Subscription Data, Policy Data, Structured Data for Exposure, and Application Data.

The NEF 103 supports different functionality, including different Exposure Application Programming Interfaces (APIs).

The NWDAF 104 supports the collection and analysis of data within the network. The NWDAF 104 is an operator-managed network analytics logical function. The NWDAF 104 is part of the 5G Core (5GC) architecture and uses the mechanisms and interfaces specified for 5GC and Operations, Administration and Maintenance (OAM). The NWDAF 104 interacts with different entities for different purposes, e.g.:
data collection based on event subscription, provided by AMF 108, SMF 109, PCF 106, Unified Data Management (UDM), AF 105 (directly or via NEF 103), and OAM;
retrieval of information from data repositories (e.g. UDR 102 via UDM for subscriber-related information);
retrieval of information about NFs (e.g. Network Repository Function (NRF) for NF-related information, and Network Slice Selection Function (NSSF) for slice-related information); and
on demand provision of analytics to consumers.

3GPP TS 23.288 v18.0.0 (December 2022) illustrates architecture enhancements for 5G System (5GS) to support network data analytics services.

The AF 105 interacts with the Third Generation Partnership Project (3GPP) Core Network (CN), and specifically in the context of this disclosure, allows external parties to use the Exposure APIs offered by the network operator.

The PCF 106 supports a unified policy framework to govern the network behaviour. Specifically, the PCF 106 can provide Policy and Charging Control (PCC) rules to a Policy and Charging Enforcement Function (PCEF), i.e. the SMF 109/UPF 110 that enforces policy and charging decisions according to provisioned PCC rules.

The ADRF 107 is a massive storage for two types of data, Collected Data (e.g., Event Exposure data), and Analytics reports.

The AMF 108 is responsible for managing mobility of UEs in the network between different gNBs (the base stations in 5G).

The SMF 109 supports different functionalities, for example the SMF 109 receives PCC rules from the PCF 106 and configures the UPF 110 accordingly.

The UPF 110 supports the handling of user plane traffic, e.g. based on the rules received from the SMF 109, for example packet inspection, packet routing and forwarding, traffic usage reporting, and different enforcement actions such as Quality of Service (QoS) handling.

Spam—Spamming is the use of messaging systems to send multiple unsolicited messages (spam) to large numbers of recipients for the purpose of commercial advertising, for the purpose of non-commercial proselytizing, for any prohibited purpose (especially the fraudulent purpose of phishing), or simply repeatedly sending the same message to the same user.

While the most widely recognised form of spam is email spam, the term is applied to similar abuses in other media: instant messaging spam, Usenet newsgroup spam, web search engine spam, spam in blogs, wiki spam, online classified ads spam, mobile phone messaging spam, Internet forum spam, junk fax transmissions, social spam, spam mobile apps, television advertising and file sharing spam.

Unsolicited messages sent in bulk by email is being received every day in each email account. Spam email is unsolicited and unwanted junk email sent out in bulk to an indiscriminate recipient list. Typically, spam is sent for commercial purposes. It can be sent in massive volume by botnets, networks of infected computers.

Spamming remains economically viable because advertisers have no operating costs beyond the management of their mailing lists, servers, infrastructures, Internet Protocol (IP) ranges, and domain names, and it is difficult to hold senders accountable for their mass mailings. The costs, such as lost productivity and fraud, are borne by the public and by Internet service providers, which have added extra capacity to cope with the volume. Spamming has been the subject of legislation in many jurisdictions.

Machine Learning (ML)—Machine learning (ML) is the study of computer algorithms that improve automatically through experience. It is seen as a part of artificial intelligence (AI). Machine learning algorithms build a model based on sample data, known as “training data”, in order to make predictions or decisions without being explicitly programmed to do so. Machine learning algorithms are used in a wide variety of applications, such as email filtering and computer vision, where it is difficult or unfeasible to develop conventional algorithms to perform the needed tasks.

There are basically 3 types of Machine Learning Algorithms:
Supervised Learning—This algorithm consists of a target/outcome variable (or dependent variable) which is to be predicted from a given set of predictors (independent variables). Using these set of variables, a function is generated that maps inputs to desired outputs. The training process continues until the model achieves a desired level of accuracy on the training data. Examples of Supervised Learning: Regression, Decision Tree, Random Forest, K-Nearest Neighbours (KNN), Logistic Regression, etc.
Unsupervised Learning—In this algorithm, there is no target or outcome variable to predict/estimate. It is used for clustering a population into different groups, which is widely used for segmenting customers in different groups for specific intervention. Examples of Unsupervised Learning include Apriori algorithm, K-means.
Reinforcement Learning—Using this algorithm, the machine is trained to make specific decisions. The machine is exposed to an environment where it trains itself continually using trial and error. This machine learns from past experience and tries to capture the best possible knowledge to make accurate business decisions. Example of Reinforcement Learning include a Markov Decision Process.

### SUMMARY

There currently exist certain challenge(s). In particular, spam traffic in mobile networks has increased significantly over the last few years and is now becoming an important target for mobile network operators (MNOs), which today lack a proper mechanism to detect and control spam traffic. Another issue is that the increasing trend for traffic encryption makes it more complex for MNO to detect spam traffic.

Existing filtering solutions which accept email and then “mark spam as such” or “move it to a spam folder” are not good solutions, as the spammer has already achieved what they intended to do, which is to present the spam email to the recipient.

Certain aspects of the disclosure and their embodiments may provide solutions to these or other challenges. In particular, this disclosure proposes a mechanism which addresses the above problems and is based on the definition of a new NWDAF Analytic relative to Spam, which allows the MNO to obtain information relative to spam (e.g. in the form of spam statistics and/or predictions) and to detect spam, and to act upon that detection.

Two main embodiments are proposed.

In the first main embodiment, a new analytic is proposed where the NWDAF assists the UPF in detecting spam. The analytic output might be a ML model (e.g. trained based on supervised ML). This solution is described below with reference to FIG. 2 which shows an example of training a ML model to detect spam (and is based on tagging/marking spam email, i.e. supervised). Once trained, the ML model for detecting spam will be provisioned in the UPFs, so, as shown in the sequence diagram in FIG. 3, the UPF will be able to detect spam. For example the UPF might include Hypertext Transfer Protocol (HTTP)/HTTP Secure (HTTPS)/ Quick UDP Internet Connections (QUIC) proxies apart from any traffic patterns which can be inferred as spam email. In this way the UPF is able to detect spam (e.g. email spam) in real-time and to block it (also in real-time).

In the second main embodiment, the new analytic can also identify the amount and types of spam vs regular traffic in the MNO's network. This part is more statistics oriented (not detection oriented) and will allow the MNO to act based on that, e.g. if the amount of spam of a certain type (e.g. email spam) is above an MNO-configured threshold (e.g. 5% of the total number of emails are spam), then the MNO might take some actions. Additionally, apart from spam related statistics, spam related predictions are also proposed.

Thus, mechanism is proposed which allows the network operator to control spam-related traffic in a simple and efficient way, based on Analytics (NWDAF).

Certain embodiments may provide one or more of the following technical advantage(s). Firstly, they can allow the network operator to support detection and control of spam traffic in a simple and efficient way, by identifying the amount and types of spam traffic in MNO's network, and which subscribers, devices, domains, applications and servers are responsible for it.

Another advantage is that existing spam detection solutions are enhanced, which are based on a single node (e.g. user equipment (UE), Application Server (AS), or UPF). In this disclosure it is proposed that the NWDAF correlates information from several sources in the network for improved spam detection and handling. In addition, existing spam detection solutions (filtering solutions) operate at application level (e.g. Outlook application client/server) and indicate to the end user which email is spam, or to suggest to move it to a spam folder. Those solutions are not good solutions, as the spammer has already achieved what they intended to do (i.e. the spam has reached the UE). In contrast, the proposed solution proposed operates at MNO/network level, so the MNO can offer its subscribers a service for spam detection and control (e.g. it allows the MNO to block spam traffic before it reaches the UE, thus avoiding the consumption of network resources).

An example use case showing the advantages of the proposed mechanism is provided. If the spam traffic in the MNO's network represents a significant amount of the total traffic (determined by the mechanism proposed herein), it gives an indication to the MNO on the need to control this traffic (e.g. by taking actions). Additionally, the mechanism proposed herein allows the identification of which subscribers are impacted by spam in their sessions, so the actions can be applied on a per individual basis.

According to a first aspect, there is provided a method performed by an analytics node in a communication network. The method comprises obtaining, from a user plane network node in the communication network, flow information relating to user data traffic conveyed by the user plane network node for one or more user equipments, UEs, in the communication network, wherein the flow information comprises measurements of traffic flows on a per traffic flow basis; and analysing the obtained flow information using a trained machine learning, ML, model to generate an analytics report, wherein the analytics report relates to presence of spam content in the user data traffic.

According to a second aspect, there is provided a method performed by an analytics node in a communication network. The method comprises obtaining, from a user plane network node in the communication network, flow information relating to user data traffic conveyed by the user plane network node for one or more user equipments, UEs, in the communication network, wherein the flow information comprises information measurements of traffic flows on a per traffic flow basis; and training a machine learning, ML, model using the obtained flow information, wherein the ML model is trained to generate an analytics report relating to presence of spam content in the user data traffic.

According to a third aspect, there is provided a method of operating a user plane network node in a communication network. The method comprises collecting flow information relating to user data traffic conveyed by the user plane network node for one or more user equipments, UEs, in the communication network, wherein the flow information comprises information measurements of traffic flows on a per traffic flow basis; and sending the collected flow information to an analytics node in the communication network.

According to a fourth aspect, there is provided a method of operating an application function or an application server. The method comprises detecting a presence of spam content in user data traffic for one or more user equipments, UEs, that operate in a communication network; and sending information relating to the detected spam content to an analytics node in the communication network.

According to a fifth aspect, there is provided a computer program product comprising a computer readable medium having computer readable code embodied therein, the computer readable code being configured such that, on execution by a suitable computer or processor, the computer or processor is caused to perform the method of any of the first aspect, the second aspect, the third aspect, the fourth aspect, or any embodiments thereof.

According to a sixth aspect, there is provided an analytics node for use in a communication network. The analytics node is configured to: obtain, from a user plane network node in the communication network, flow information relating to user data traffic conveyed by the user plane network node for one or more user equipments, UEs, in the communication network, wherein the flow information comprises measurements of traffic flows on a per traffic flow basis; and analyse the obtained flow information using a trained machine learning, ML, model to generate an analytics report, wherein the analytics report relates to presence of spam content in the user data traffic.

According to a seventh aspect, there is provided an analytics node for use in a communication network. The analytics node is configured to: obtain, from a user plane network node in the communication network, flow information relating to user data traffic conveyed by the user plane network node for one or more user equipments, UEs, in the communication network, wherein the flow information comprises information measurements of traffic flows on a per traffic flow basis; and train a machine learning, ML, model using the obtained flow information, wherein the ML model is trained to generate an analytics report relating to presence of spam content in the user data traffic.

According to an eighth aspect, there is provided a user plane network node for use in a communication network. The user plane network node is configured to collect flow information relating to user data traffic conveyed by the user plane network node for one or more user equipments, UEs, in the communication network, wherein the flow information comprises information measurements of traffic flows on a per traffic flow basis; and send the collected flow information to an analytics node in the communication network.

According to a ninth aspect, there is provided an application function or an application server. The application function or application server is configured to detect a presence of spam content in user data traffic for one or more user equipments, UEs, that operate in a communication network; and send information relating to the detected spam content to an analytics node in the communication network.

According to a tenth aspect, there is provided an analytics node for use in a communication network. The analytics node comprises a processor and a memory, said memory containing instructions executable by said processor whereby said analytics node is operative to: obtain, from a user plane network node in the communication network, flow information relating to user data traffic conveyed by the user plane network node for one or more user equipments, UEs, in the communication network, wherein the flow information comprises measurements of traffic flows on a per traffic flow basis; and analyse the obtained flow information using a trained machine learning, ML, model to generate an analytics report, wherein the analytics report relates to presence of spam content in the user data traffic.

According to an eleventh aspect, there is provided an analytics node for use in a communication network. The analytics node comprises a processor and a memory, said memory containing instructions executable by said processor whereby said analytics node is operative to: obtain, from a user plane network node in the communication network, flow information relating to user data traffic conveyed by the user plane network node for one or more user equipments, UEs, in the communication network, wherein the flow information comprises information measurements of traffic flows on a per traffic flow basis; and train a machine learning, ML, model using the obtained flow information, wherein the ML model is trained to generate an analytics report relating to presence of spam content in the user data traffic.

According to a twelfth aspect, there is provided a user plane network node for use in a communication network. The user plane network node comprises a processor and a memory, said memory containing instructions executable by said processor whereby said user plane network node is operative to collect flow information relating to user data traffic conveyed by the user plane network node for one or more user equipments, UEs, in the communication network, wherein the flow information comprises information measurements of traffic flows on a per traffic flow basis; and send the collected flow information to an analytics node in the communication network.

According to a thirteenth aspect, there is provided an application function or an application server. The application function or application server comprises a processor and a memory, said memory containing instructions executable by said processor whereby said application function or application server is operative to detect a presence of spam content in user data traffic for one or more user equipments, UEs, that operate in a communication network; and send information relating to the detected spam content to an analytics node in the communication network.

### BRIEF DESCRIPTION OF THE DRAWINGS

Some of the embodiments contemplated herein will now be described more fully with reference to the accompanying drawings, in which:

FIG. 1 illustrates part of a 5G system reference architecture;

FIG. 2 is a signalling/process diagram illustrating a supervised ML model training process;

FIG. 3 is a signalling/process diagram illustrating an application of the ML model trained according to FIG. 2 to spam emails;

FIG. 4 is a flow chart illustrating a method of operating an analytics node in accordance with some embodiments;

FIG. 5 is a flow chart illustrating another method of operating an analytics node in accordance with some embodiments;

FIG. 6 is a flow chart illustrating a method of operating a user plane network node in accordance with some embodiments;

FIG. 7 is a flow chart illustrating a method of operating an application function or application server in accordance with some embodiments;

FIG. 8 shows a core network node in accordance with further embodiments; and

FIG. 9 is a block diagram illustrating a virtualization environment in which functions implemented by some embodiments may be virtualized.

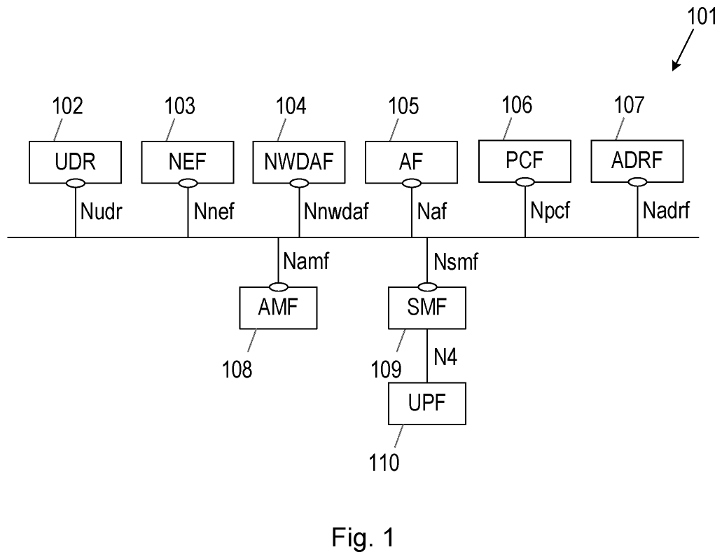

### DETAILED DESCRIPTION

Some of the embodiments contemplated herein will now be described more fully with reference to the accompanying drawings. Embodiments are provided by way of example to convey the scope of the subject matter to those skilled in the art.

It will be appreciated that the techniques described herein can be implemented in future versions of the 3GPP Technical Specification (TS) 23.288 v18.0.0 (December 2022) “Architecture enhancements for 5G System (5GS) to support network data analytics services”. For example the specification can define a new NWDAF analytic related to spam, which allows the MNO to obtain information relative to spam (e.g. in the form of spam statistics and/or predictions), to detect spam and to act upon it.

As noted above, this disclosure provides a mechanism which allows the network operator to control spam-related traffic in a simple and efficient way. Spam content or spam-related traffic is any type of content or traffic that is unsolicited and/or unwanted by a UE that it is sent to, and/or unsolicited and/or unwanted by one or more destinations for the user data traffic (e.g. an email server). Spam content and/or spam traffic can relate to or contain advertising, phishing content, malware, etc.

The proposed mechanism is outlined below.

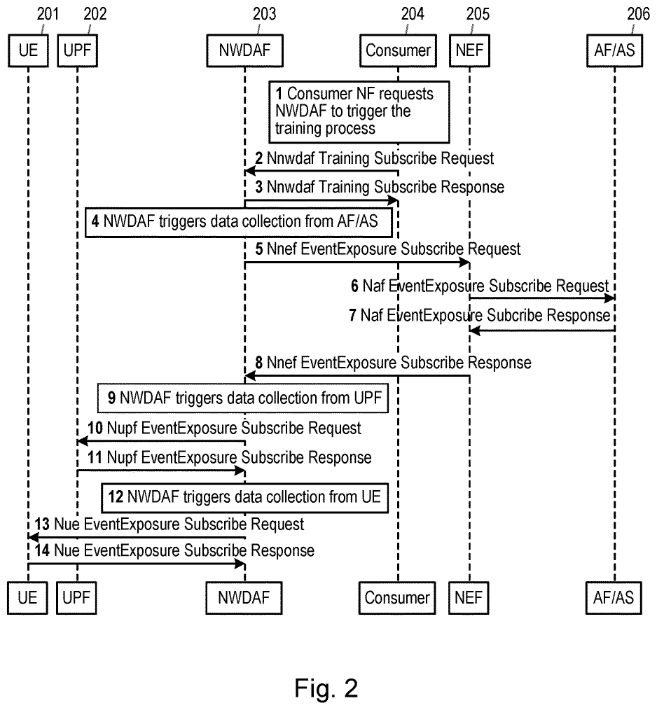

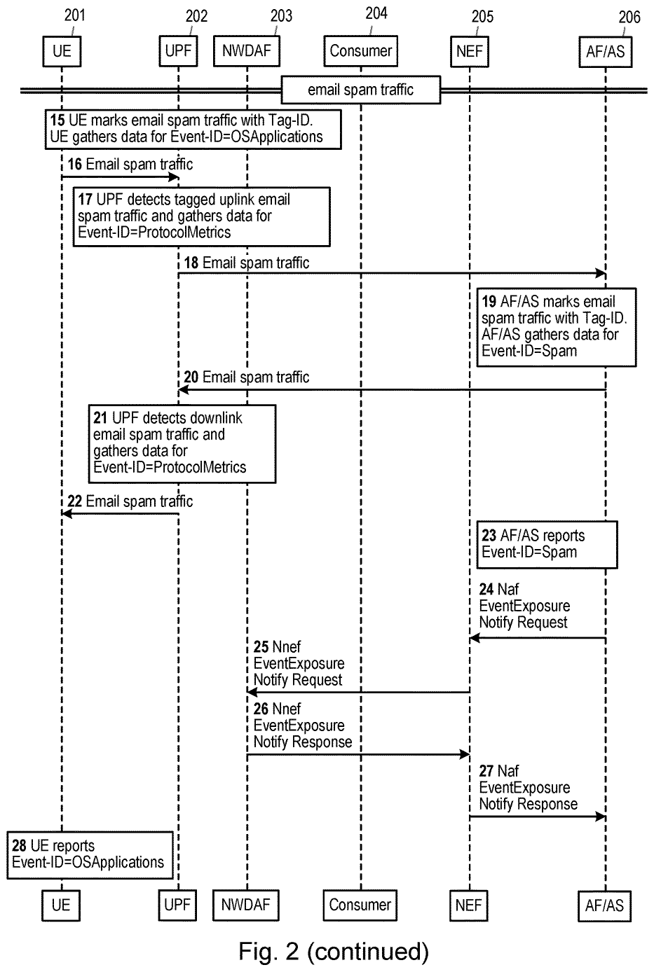

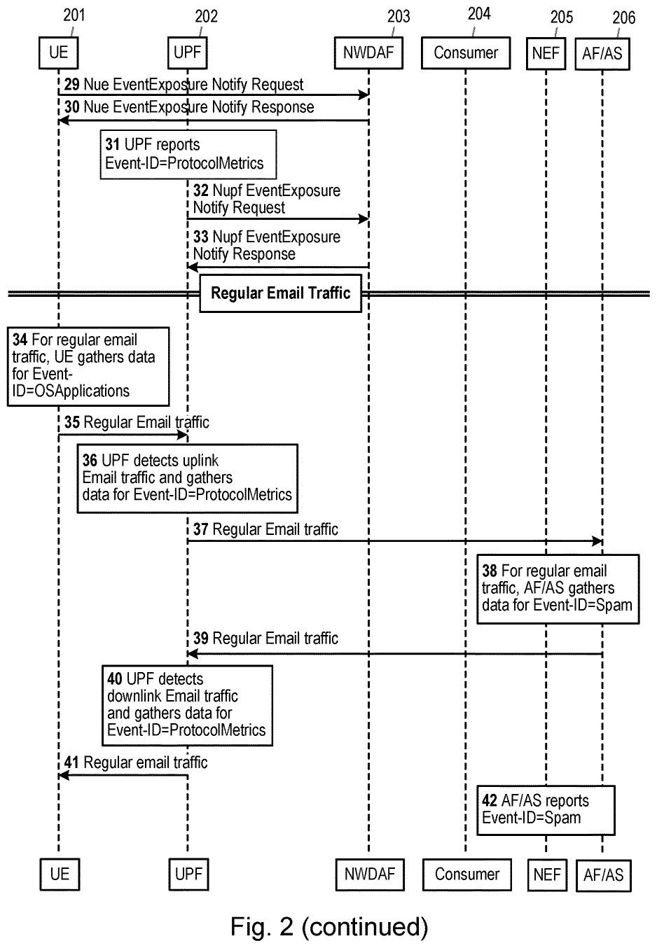

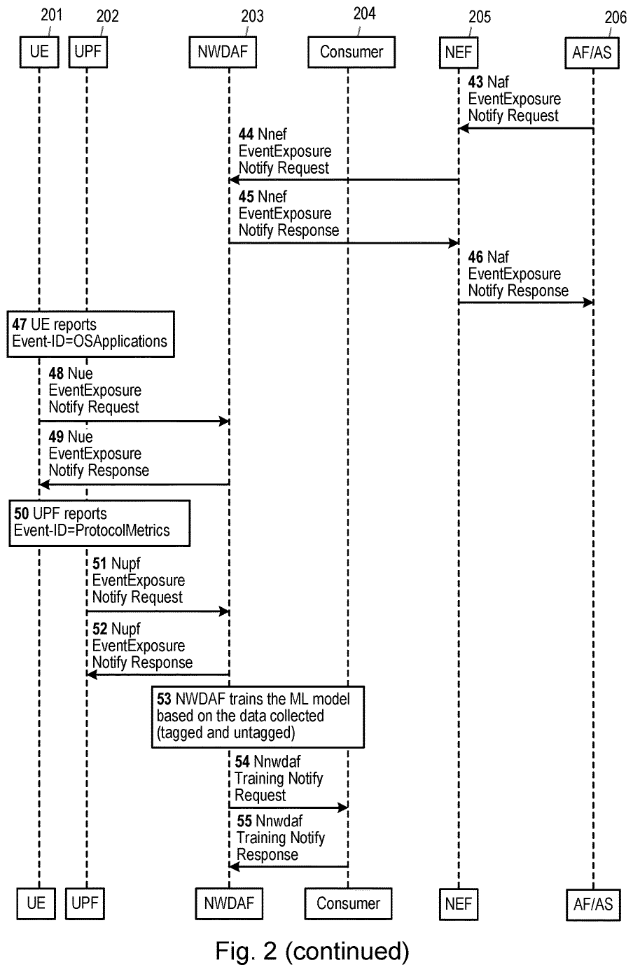

Initially a trained ML model is available at the NWDAF. FIG. 2 and the accompanying description explains in more detail how this ML model can be trained.

A consumer (e.g. any NF, such as PCF, OAM, AF) subscribes to the NWDAF for a spam-related analytic. For example the consumer can send an analytics subscription request to the NWDAF indicating ‘spam’ in an identifier for the analytics (e.g. Analytic-ID=Spam). The analytics subscription request can be a Nnwdaf_AnalyticsSubscription_Subscribe message. The analytics subscription request can include any one or more of the following parameters:
Analytic identifier (Analytic-ID)=Spam
Type of analytics (Analytic-Type)=(any one or more of) Email, Instant Messaging (IM), Short Message Service (SMS), Multimedia Message System/Service (MMS), phone call, etc. This indicates the specific type of spam of interest to the consumer. When no specific spam type is included, it is considered to be a request for spam analytics irrespective of the spam type (i.e. for any type of spam).
(Optional) Identifiers of one or more UEs that are the target of the analytics. E.g. the identifiers can be a UE identifier (UE-ID) or list of UE-IDs, a UE group identifier (UE-Group-ID) or list of UE-Group-IDs, or ‘AnyUE’. If no identifier is present, or if the identifier is indicated as AnyUE, then any/all UEs are the target of the analytics.

Based on the above analytic subscription, the NWDAF triggers data collection from one or more of the following network functions, UDR, ADRF, AF/AS, Short Message Service Function (SMSF), and UPF, and optionally also one or more UEs.

The NWDAF can retrieve subscriber data from the UDR. The NWDAF can retrieve subscriber data (specifically historic spam-related information for this subscriber) from the ADRF.

In the case of the AF/AS, the type of data collected by the NWDAF can depend on the type of analytics (i.e. type of spam) that is of interest. A precondition to collecting data from the AF/AS is for the AF/AS to exchange capabilities with the MNO (e.g. via the NEF), specifically to indicate support for exposure of spam-related metrics. This assumes a collaborative solution between the MNO and the Content Provider (e.g. email content providers such as Microsoft Outlook or Google Gmail). This is valid for the Mobile Broadband (MBB) segment, but particularly for the Enterprise segment (e.g. a MNO might provide spam analytics as a service to their Enterprise customers). For discovery, the AF (e.g. a Microsoft AF for Outlook) would typically register in the MNO's NEF to indicate support of this event (e.g. related to email data), so the MNO's NWDAF can trigger data collection from the AF. The AF would internally collect data from the Microsoft Outlook application servers. This is typically depicted as AF/AS (Application Function/Application Server) in 3GPP analytics wording.

In the case of Analytic-Type=email, the data collection by the NWDAF from the AF/AS related to email traffic detected by the AF/AS can include, for each detected email transaction, any one or more of: a timestamp (start and stop times); whether it is suspected of being spam or not based on AF/AS (application level) spam filtering procedures; other information e.g. confidence level; and related application data (e.g. Gmail, Hotmail). It will be appreciated that this is not an exhaustive list, and other types of data/information relating to emails can be collected from the AF/AS.

In the case of Analytic-Type=IM, the data collection by the NWDAF from the AF/AS related to IM traffic detected by the AF/AS can include, for each detected IM transaction, any one or more of: a timestamp (start and stop times); whether it is suspected of being spam or not based on AF/AS (application level) spam filtering procedures; other information e.g. confidence level; and related application data (e.g. WhatsApp). It will be appreciated that this is not an exhaustive list, and other types of data/information relating to IM can be collected from the AF/AS.

In the case of Analytic-Type=SMS, the data collection by the NWDAF from the AF/AS related to SMS traffic detected by the AF/AS can include, for each detected SMS transaction, any one or more of: a timestamp (start and stop times); whether it is suspected of being spam or not based on AF/AS (application level) spam filtering procedures; other information e.g. confidence level; and related application data (e.g. SMS Server). It will be appreciated that this is not an exhaustive list, and other types of data/information relating to SMS can be collected from the AF/AS.

In the case of Analytic-Type=MMS, the data collection by the NWDAF from the AF/AS related to MMS traffic detected by the AF/AS can include, for each detected MMS transaction, any one or more of: a timestamp (start and stop times); whether it is suspected of being spam or not based on AF/AS (application level) spam filtering procedures; other information e.g. confidence level; and related application data (e.g. MMS Server). It will be appreciated that this is not an exhaustive list, and other types of data/information relating to MMS can be collected from the AF/AS.

In the case where the NWDAF retrieves data from the SMSF, the Analytic-Type will be SMS, and the data will relate to SMS transactions/traffic. The data collected by the NWDAF relates to SMS-related traffic detected by the SMSF, and, for each detected SMS flow or transaction, the data can include any one or more of: a timestamp (start and stop times); a volume (e.g. in bytes) of the SMS flow or transaction; 5-tuple/s; a list of Server IP addresses. It will be appreciated that this is not an exhaustive list, and other types of data/information relating to SMS can be collected from the SMSF. 5-tuple refers to a set of data that identifies a Transmission Control Protocol (TCP) session, and includes: a source Internet Protocol (IP) address, source port, destination IP address, destination port, and the transport protocol.

If the NWDAF retrieves data from the UPF, the data collected can depend on the type of analytics.

In the case of Analytic-Type=email, the data collection by the NWDAF from the UPF related to email traffic detected by the UPF can include, for each detected email flow or email transaction, any one or more of: a timestamp (start and stop times); volume (e.g. in bytes) of the email flow or transaction; 5-tuple/s; related application data or domain data (e.g. gmail.com, Hotmail. com); and a list of Server IP addresses. It will be appreciated that this is not an exhaustive list, and other types of data/information relating to emails can be collected from the UPF. Alternatively, the UPF may report raw data (e.g. raw email packets).

In the case of Analytic-Type=IM, the data collection by the NWDAF from the UPF related to IM traffic detected by the UPF can include, for each detected IM flow transaction, any one or more of: a timestamp (start and stop times); volume (e.g. in bytes) of the IM flow or IM transaction; 5-tuple/s; related application data or domain data (e.g. whatsapp. com); and a list of Server IP addresses. It will be appreciated that this is not an exhaustive list, and other types of data/information relating to IMs can be collected from the UPF.

In the case of Analytic-Type=MMS, the data collection by the NWDAF from the UPF related to MMS traffic detected by the UPF can include, for each detected MMS flow transaction, any one or more of: a timestamp (start and stop times); volume (e.g. in bytes) of the MMS flow or MMS transaction; 5-tuple/s; and a list of Server IP addresses. It will be appreciated that this is not an exhaustive list, and other types of data/information relating to MMS can be collected from the UPF.

If the NWDAF retrieves data from one or more UEs, the data collected can depend on the type of analytics. A precondition for the NWDAF to collect information from a UE is for the UE to exchange capabilities with MNO, specifically to indicate support for exposure of spam-related metrics. This assumes a collaborative solution between the MNO and the UE application (email apps, e.g. Microsoft Outlook or Google Gmail). However, collecting data from the UE means that the spam traffic has already reached the UE, so the NWDAF collecting data from the UE is not ideal, and it would be better to collect the data from the server (e.g. AF/AS) instead.

In the case of Analytic-Type=email, IM, SMS or MMS, the data collection by the NWDAF from the UE related to email/IM/SMS/MMS traffic detected by the UE can include, for each detected email/IM/SMS/MMS flow or transaction, any one or more of: an identifier of an application client that triggered the email/IM/SMS/MMS traffic; a timestamp (start and stop times); volume (e.g. in bytes) of the email/IM/SMS/MMS flow or transaction; 5-tuple/s; and a list of Server IP addresses. It will be appreciated that this is not an exhaustive list, and other types of data/information relating to emails/IM/SMS/MMS can be collected from the UE.

Once the NWDAF has collected the above data, the NWDAF runs analytic processes and generates the analytics result (Analytic-Result). The analytics result can include any one or more of the following types of information:
Analytic identifier (Analytic-ID)=Spam
Type of analytics (Analytic-Type)=(any one or more of) email, IM, SMS, MMS, etc.
An indication of a normal or abnormal scenario. In case the NWDAF determines that traffic (for the requested type) corresponds to a normal (non-spam) scenario (e.g. a normal email, IM, SMS or MMS traffic) or an abnormal (spam) scenario, this can be indicated in the Analytic-Result, optionally including a confidence level in the normal/abnormal decision (e.g. a percentage from 0% to 100%).
A list of identifiers of one or more UEs (e.g. list of UE-IDs). This can identify which UE-IDs have been found to which spam is being sent (e.g. on a per spam type basis). Each UE-ID might include the subscriber identifier (e.g. Subscription Permanent Identifier (SUPI)/International Mobile Subscriber Identity (IMSI)), the subscriber public identifier (Public User Identity (PUI)/Mobile Station International Subscriber Directory Number (MSISDN)) and/or device identifier (Public Equipment Identity (PEI)/International Mobile Equipment Identity (IMEI)).
(Optional) indicates of a type(s) of spam detected. For example, in the case of Analytic-Type=email, the type of spam detected can be any of junk emails, emails with links to malicious sites or malicious attachments, unwanted emails from a specific site or specific individual, etc. The NWDAF may be able to detect the spam type based, e.g., on the supervised ML model training process, which can result in a different ML model for each type of spam.
(Optional) a list of identifiers of applications (e.g. list of App-IDs). This can identify the App-IDs where spam traffic has been found.
(Optional) a list of Server IPs. This can identify the Server IPs where spam traffic has been found.
(Optional) spam volume (e.g. the data volume of the spam), including the percentage with respect to the total traffic volume. This can be used e.g., to determine how much spam traffic there is on a global basis, on a per UE-ID basis, and/or on a per spam type basis.
(Optional) a recommended action, such as a traffic management action, or other type of action. For example, if the NWDAF determines that spam traffic has been found and the confidence level (of it being spam) is high, the recommended action can be to block spam traffic for the suspect domains and/or Server IPs. If the NWDAF determines that spam traffic has been found and the confidence level (of it being spam) is medium, the recommendation can be for traffic steering, e.g. to steer a copy of the suspect spam traffic towards an offline analytics engine. Another recommended action can be to store an indication that spam content has been identified for the UE-ID, with this indication stored as part of subscriber data in UDR and/or ADRF, etc.

Based on the results of the analytics (Analytic-Result), the Consumer (e.g. PCF) can apply or take an action. As noted above, the Analytic-Result may include a recommended traffic management action. In this case, the Consumer may take the recommended action, or decide to take a different action. If the Analytic-Result does not include a recommended action, or if the Consumer decides to take a different action, the action may be as follows. For example, if the NWDAF determines that spam traffic has been found and the confidence level (of it being spam) is high, the Consumer can take an action to block spam traffic for the suspect domains and/or Server IPs. If the NWDAF determines that spam traffic has been found and the confidence level (of it being spam) is medium, the Consumer can take an action to perform traffic steering, e.g. to steer a copy of the suspect spam traffic towards an offline analytics engine. Another action can be to store, as part of subscriber data in UDR and/or ADRF, subscriber data (for each UE-ID) that indicates the subscriber/device being a subscriber/device where spam has been detected, along with the corresponding spam information.

Finally, the consumer might be an AF (e.g. Gmail) that requests an MNO to block spam of a certain type (e.g. email).

FIG. 2 is a signalling/process diagram illustrating a supervised ML model training process according to the techniques described herein. FIG. 2 shows the signalling between a UE 201, a UPF 202, a NWDAF 203, a Consumer 204 (which is a NF that is to consume or use the analytics provided by the NWDAF 203), a NEF 205 and an AF/AS 206. The UE 201, UPF 202, NWDAF 203, Consumer 204, and NEF 205 can be considered to be part of a communication network (e.g. a 3GPP 5G or 6^{th} Generation (6G) network), and the AF/AS 206 is external to the communication network. Each signal and step in FIG. 2 is numbered, and this signal and step numbering is referenced in this description with the prefix “2-”. Thus, in FIG. 2 step 1 by the Consumer 204 is referred to in this description as step 2-1, and signal 2 between the Consumer 204 and the NWDAF 203 is referred to as signal 2-2.

It will be appreciated that the illustrated ML model training process is considered a supervised learning/training process as sample/test spam content and sample/test non-spam content are transmitted through the communication network and the sample spam content is identifiable to the relevant nodes/functions in the communication network by use of a Tag-ID or other identifier.

Thus, sample spam content/spam traffic is marked with a Tag-ID (e.g. Differentiated Services Code Point (DSCP) marking, an IP Options header, etc). This marking is just for training purposes to enable supervised ML. However, it will be appreciated that unsupervised ML, or any other type of technique for training the ML model can be used. Once the NWDAF's ML model for detection of spam is trained (e.g. supervised), the actual detection of spam content is not based on the presence of any marking.

In step 2-1 of FIG. 2 the Consumer 204 (which can be any type of NF, e.g. an OAM) decides that the NWDAF 203 is to start the model training process for a model that is able to detect spam content. Thus, the Consumer 204 sends a subscription request (signal 2-2) to the NWDAF 203 to trigger the training process relative to a spam-based analytic (which is referred to herein as Analytic-ID=Spam). The subscription request can be a Nnwdaf_Training_Subscribe request message. The subscription request can include any one or more of the parameters described above, i.e. any one or more of an Analytic identifier, type of analytics, and identifiers of one or more UEs or UE groups that are the target of the analytics. In the example shown in FIG. 2, Analytic-Type=email, and there is an identifier of a certain UE (UE-ID).

In addition, the subscription request (2-2) can comprise a parameter that includes one or more predetermined identifiers that can be used to identify training spam content as it passes through the UPF 202 and other network functions. This predetermined identifier is referred to as Tag-ID. Predetermined identifiers may be used by the UE(s) 201 to mark outgoing (email) spam traffic as spam, and/or by the UPF 202 to detect (email) spam traffic passing through the UPF 202. In an alternative embodiment, the Tag-ID value(s) are determined/configured at the AF/AS 206, and are not included in the subscription request 2-2.

The NWDAF 203 responds to the subscription request signal 2-2 with a successful response (accepting the request) (signal 2-3).

In step 2-4 the NWDAF 203 triggers data collection from the AF/AS 206 (through the NEF 205), specifically to retrieve information relative to (email) traffic detected by the AF/AS 206 for the UE 201 with UE-ID. To do this, the NWDAF 203 triggers a subscription request message (e.g. a Nnef_EventExposure_Subscribe request message) to the NEF 205 (signal 2-5). The subscription request message (signal 2-5) can include any one or more of the following parameters:
An event identifier (Event-ID) indicating the type of event the request relates to, e.g. Event-ID=Spam
An event filter (Event-Filter) indicating a content type for the event, e.g. Event-Filter=email (in the example of FIG. 2)
Identifiers of one or more UEs that are the target of the analytics, e.g. UE-ID in this example
Predetermined identifier (Tag-ID) to be used to label test spam content. This is optional for the subscription request 2-5 as it is also possible for the Tag-ID value(s) to be determined/configured at the AF/AS 206.

The NEF 205 forwards the subscription request message to the AF/AS 206 (signal 2-6). This message can be a Naf_EventExposure_Subscribe request message. The subscription request message 2-6 comprises the same parameters as the subscription request message 2-5 received from the NWDAF 203.

The AF/AS 206 responds to the subscription request message signal 2-6 with a successful response (accepting the request) (signal 2-7).

The NEF 205 responds to the request message signal 2-5 with a successful response (accepting the request) (signal 2-8).

In step 209, the NWDAF 203 triggers data collection from the UPF 202 (or an SMSF in the case of SMS), specifically to retrieve information relative to (email) traffic detected by UPF 202 for the relevant UE-ID(s). In order to do this, NWDAF 203 sends a subscription request (signal 2-10) to the UPF 202. This can be a Nupf_EventExposure_Subscribe request message. The subscription request can include the same or similar parameters to the subscription request message 2-5. However, in the case of the subscription request 2-10 sent to the UPF 202, the event identifier can be, e.g. Event-ID=ProtocolMetrics (also referred to herein as “flow information”). Again, the predetermined identifier (Tag-ID) is optional as it is also possible for the Tag-ID value(s) to be determined/configured at the UPF 202.

Those skilled in the art will appreciate specific mechanisms that can be used by the NWDAF 203 to trigger data collection from the UPF 202. For example, existing mechanisms proposed in 3GPP TR 23.700-91 can be used (e.g. through SMF or directly, assuming a service based UPF).

The UPF 202 responds to the request message with a successful response (accepting the request) (signal 2-11).

In step 2-12 the NWDAF 203 triggers data collection from the UE 201, specifically to retrieve information relative to email traffic for the indicated UE-ID. In order to do this, the NWDAF 203 sends a subscription request 2-13 to the UE 201. This subscription request can be a Nue_EventExposure_Subscribe request message. The subscription request 2-13 can include the same or similar parameters to the subscription request message 2-5. However, in the case of the subscription request 2-13 sent to the UE 201, the event identifier can be, e.g. Event-ID=OSApplications (also referred to herein as “application information”), as information is requested on the operation of applications at the UE operating system (OS) level. Again, the predetermined identifier (Tag-ID) is optional as it is also possible for the Tag-ID value(s) to be determined/configured at the UE 201.

Those skilled in the art will appreciate specific mechanisms that can be used by the NWDAF 203 to trigger data collection from the UE 201. For example, existing mechanisms proposed in 3GPP TR 23.700-91 can be used.

The UE 201 responds to the request message with a successful response (accepting the request) (signal 2-14).

In step 2-15 the UE 201 marks the test spam traffic (i.e. emails) that is to be sent through the communication network to the AF/AS 206 with the relevant Tag-ID and gathers data for the Event-ID=OSApplications. Specifically, the UE 201 can store any of the following types of information for each detected content transaction (e.g. each email):
Tagged (indicating this transaction is tagged)
an application identifier (App-ID) that indicates which application client in the UE 201 triggered the email traffic
timestamp (start and stop)
data volume (e.g. in bytes) of the transaction
5-tuple of the Transmission Control Protocol/Internet Protocol (TCP/IP) connection
a list of Server IP addresses.

The UE 201 then transmits the test spam traffic (signal 2-16). This traffic passes via the UPF 202.

In step 2-17, the UPF 202 detects the uplink (email) traffic from the UE 201, and gathers data for the Event-ID ProtocolMetrics. The test spam traffic can be detected by the UPF 202 according to the Tag-ID that the uplink traffic marked with. The flow information gathered by the UPF 202 and stored can comprise, for each instance of spam content, any one or more of the following types information:
Tagged (indicating this transaction is tagged)
timestamp (start and stop)
data volume (e.g. in bytes) of the transaction
5-tuple of the TCP/IP connection
Related application or domain data (e.g. Gmail.com, Hotmail.com)
a list of Server IP addresses.

The test spam traffic continues from the UPF 202 to the AF/AS 206 (signal 2-18).

In step 2-19 the AF/AS 206 gathers data (external application data) for the Event-ID=Spam. The external application information gathered by the AF/AS 206 can comprise, for each instance of spam content, any one or more the following types of information:
Event-ID=Spam
UE-ID, to indicate the target UE/s for this event
SpamInfo (i.e. information about the spam content).

The SpamInfo can include any one or more of:
Tagged (indicating this transaction is tagged)
Timestamp (start and stop)
If the content is suspected of being spam or not, which is based on AF/AS (application level) spam filtering procedures
Other information e.g. a confidence level for whether the content is spam or not
Related application data (e.g. does it relate to Gmail, Hotmail, etc.)

In step 2-19 (or in a separate step) the AF/AS 206 can send test spam content to the UE 201. This test spam content can be marked with an appropriate Tag-ID. This test spam content may be in response to the content received from the UE 201, or it may be independent of that content. In some embodiments, the UE 201 may not send any test spam traffic itself, and only the AF/AS 206 sends test spam traffic.

The test spam content sent by the AF/AS 206 is shown as signal 2-20.

In step 2-21 the UPF 202 detects the downlink test spam traffic (e.g. via the included Tag-ID) and gathers data for Event-ID=ProtocolMetrics. The type of data gathered can be the same as for the uplink test spam content (step 2-17). The UPF 202 forwards the test spam traffic to the UE 201 (signal 2-22).

In step 2-23 the AF/AS 206 reports data for the Event-ID=Spam to the NWDAF 203 via the NEF 205 (signal 2-24 to the NEF 205, and signal 2-25 from the NEF 205 to the NWDAF 203). This reporting can be performed periodically. The information reported via signal 2-24 (and then via signal 2-25) can be the information gathered in step 2-23.

Signal 2-24 can be a notification message, such as a Naf_EventExposure_Notify request message. Signal 2-25 can be a notification message, such as a Nnef_EventExposure_Notify request message.

The NWDAF 203 answers the notification request message (signal 2-25) with a successful response (accepting the request), as shown by signal 2-26 to the NEF 205 and signal 2-27 from the NEF 205 to the AF/AS 206.

At step 2-28 the UE 201 can continue gathering data for Event-ID=OSApplications, and at some time point the UE 201 reports data for the Event-ID=OSApplications. The UE 201 may report the data periodically. The UE 201 can notify the NWDAF 203 by sending a notification message (signal 2-29) to the NWDAF 203 comprising the information gathered by the UE 201 in step 2-15. The notification message can be a Nue_EventExposure_Notify request message. The data sent to the NWDAF 203 can include the types of information gathered according to step 2-15 above.

The NWDAF 203 answers the notification request message (signal 2-29) with a successful response (accepting the request), as shown by signal 2-30 to the UE 201.

At step 2-31 the UPF 202 can continue gathering data for Event-ID=ProtocolMetrics, and at some time point the UPF 202 reports data for the Event-ID=ProtocolMetrics to the NWDAF 203. The UPF 202 may report the data periodically. The UPF 202 can notify the NWDAF 203 by sending a notification message (signal 2-32) to the NWDAF 203 comprising the information gathered by the UPF 202 in step 2-17 and/or step 2-21. The notification message can be a Nupf_EventExposure_Notify request message. The data sent to the NWDAF 203 can include the types of information gathered according to steps 2-17 and/or 2-21 above.

The NWDAF 203 answers the notification request message (signal 2-32) with a successful response (accepting the request), as shown by signal 2-33 to the UPF 202.

In the following steps/signals 2-34 to 2-52, test regular (i.e. non-spam) content is sent between the UE 201 and AF/AS 206, data/information is collected about this test regular content, and the data/information is passed to the NWDAF 203.

Steps/signals 2-34 to 2-52 correspond respectively to steps/signals 2-15 to 2-33, except that the test regular content does not include a Tag-ID indicating that the content is test spam content (or alternatively the test regular content includes a Tag-ID or other identifier indicating that the content is not spam).

Although the sending and observation of the test regular (non-spam) content (steps/signals 2-34 to 2-52) is shown as taking place after the sending and observation of the test spam content (steps/signals 2-15 to 2-33), this is merely for ease of illustration and explanation, and it will be appreciated that test regular content could be sent and observed first, or both test regular content and test spam content can be sent interchangeably (provided suitable identifiers (e.g. Tag-ID) are used) and observed.

Once sufficient information has been obtained about the test spam content (tagged data) and test regular content (untagged data), in step 2-53 the NWDAF 203 can train the ML model based on the collected data (tagged and untagged). The resulting ML model can be obtained through supervised ML algorithms like decision trees, random forest, regression, etc.

The NWDAF 203 then notifies the consumer 204 that the training process is finished by sending a request message (signal 5-54) to the consumer 204. This message can be a Nnwdaf_Training_Notify request message.

The consumer 204 can respond to the message (signal 2-54) with a notify response (signal 2-55).

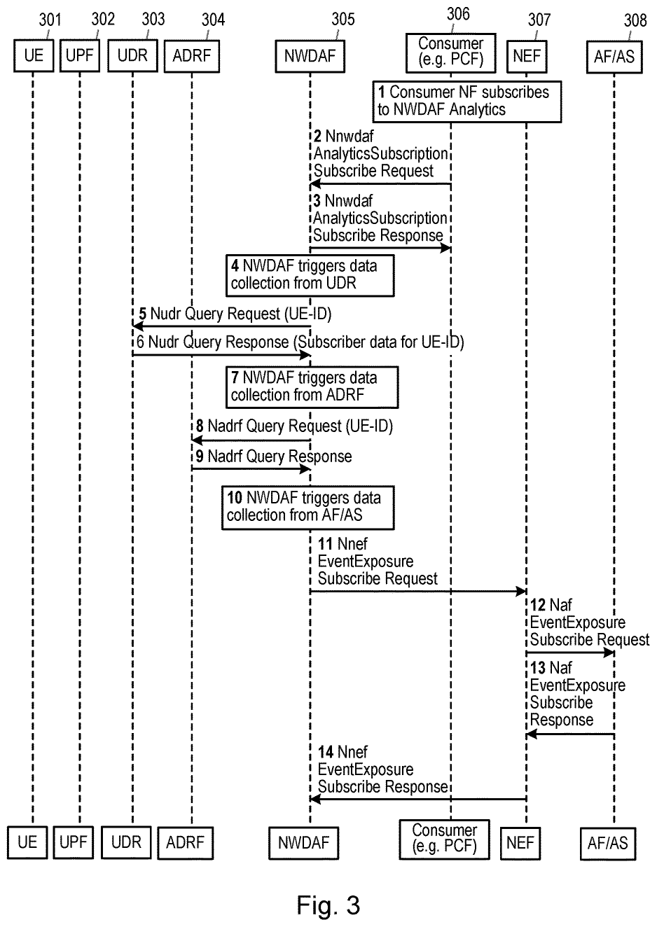

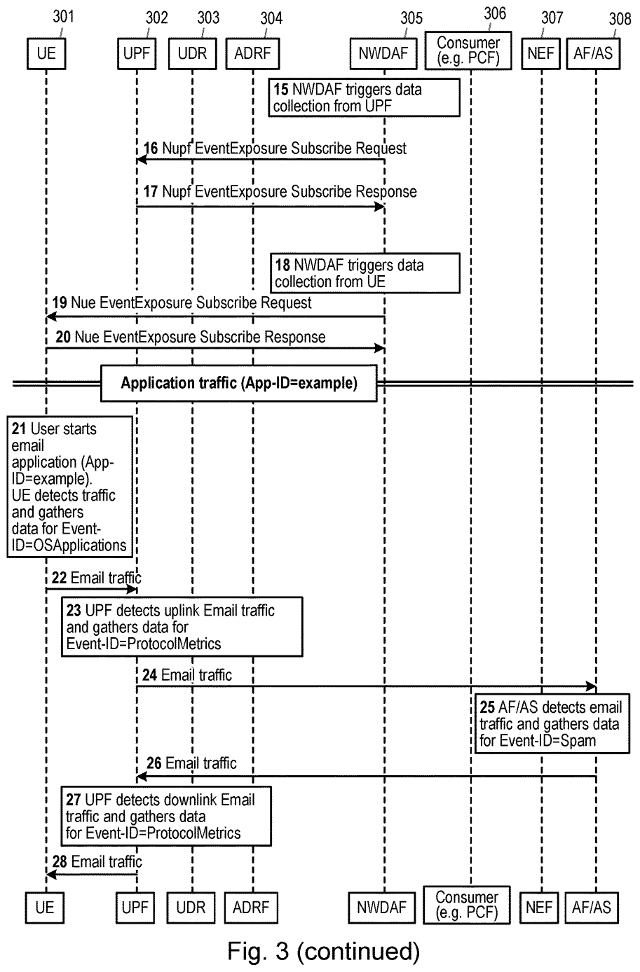

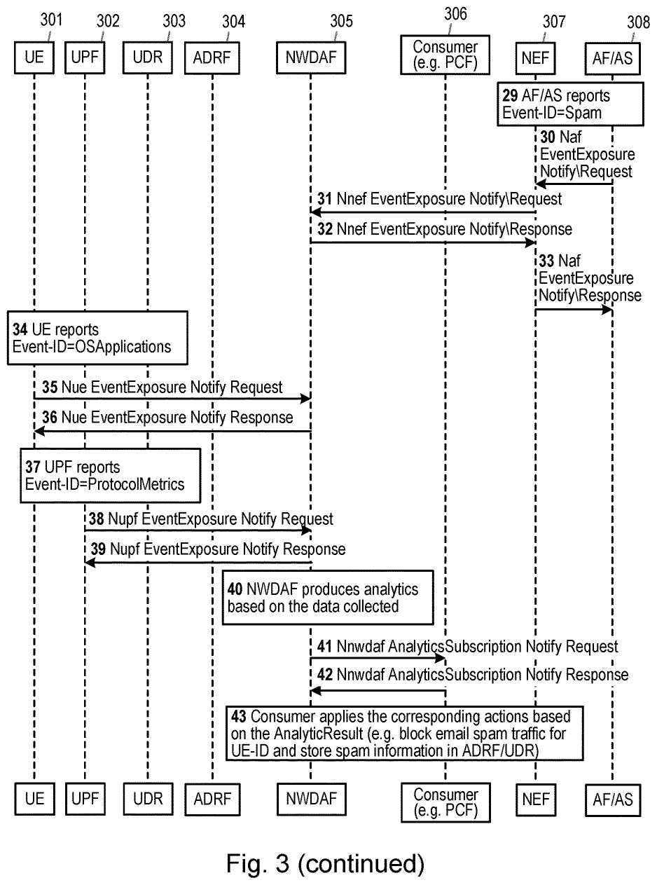

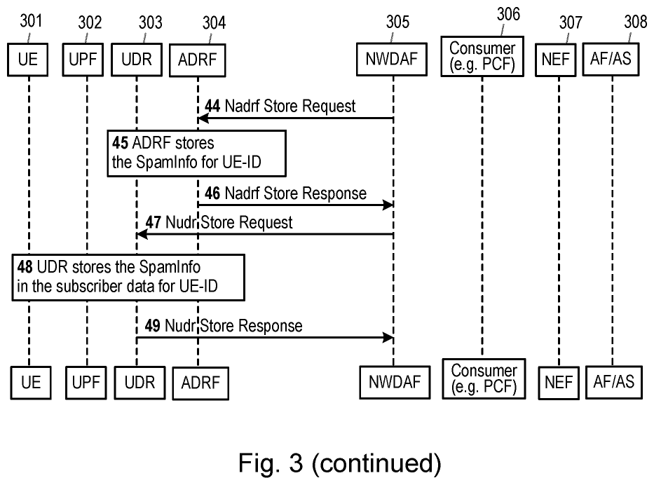

FIG. 3 is a signalling/process diagram illustrating the application of a ML model trained according to the process in FIG. 2 to a spam email use case. FIG. 3 shows the signalling between a UE 301, a UPF 302, a UDR 303, ADRF 304, NWDAF 305, a Consumer 306 (e.g. a PCF), a NEF 307 and an AF/AS 308. The UE 301, UPF 302, UDR 303, ADRF 304, NWDAF 305, Consumer 306, and NEF 307 can be considered to be part of a communication network (e.g. a 3GPP 5G or 6G network), and the AF/AS 308 is external to the communication network. Each signal and step in FIG. 3 is numbered, and this signal and step numbering is referenced in this description with the prefix “3-”. Thus, step 1 by the Consumer 306 is referred to in this description as step 3-1, and signal 2 between the Consumer 306 and the NWDAF 305 is referred to as signal 3-2.

In step 3-1 a consumer 306 (which can be any type of NF, e.g. a PCF or an OAM) subscribes to analytics to be provided by NWDAF 305. Thus, the Consumer 204 sends an analytics subscription request (signal 3-2) to the NWDAF 305 to subscribe to the analytics. The analytics subscription request can indicate that the request is for a spam-based analytic, e.g. by indicating Analytic-ID=Spam. The analytics subscription request can be a Nnwdaf_AnalyticsSubscription_Subscribe request message. The analytics subscription request can include any one or more of the parameters defined above, e.g. any of an Analytic identifier, a type of analytics, and identifiers of one or more UEs or UE groups that are the target of the analytics.

The NWDAF 305 responds to the analytics subscription request signal 3-2 with a successful response (accepting the request) (signal 3-3).

In step 3-4, the NWDAF 305 triggers data collection from the UDR 303. In particular, the NWDAF 305 sends a query request (signal 3-5) to the UDR 303 for subscriber data relative to the UE(s) with the UE-ID(s) indicated in the analytics subscription request 3-2. The query request may be a Nudr_Query request message, that includes UE-ID as a parameter.

The UDR 303 returns the subscriber data for UE-ID to the NWDAF 305 (signal 3-6).

In step 3-7, the NWDAF 305 triggers data collection from the ADRF 304. In particular, the NWDAF 305 sends a query request (signal 3-8) to the ADRF 304 for subscriber data relative to the UE(s) with the UE-ID(s) indicated in the analytics subscription request 3-2. The query request may be a Nadrf_Query request message, that includes UE-ID as a parameter.

The ADRF 304 returns the subscriber data for UE-ID to the NWDAF 305 (signal 3-9). The subscriber data may indicate information relating to historical spam content, e.g. that the subscriber receives a high amount of spam content, etc.

In step 3-10, the NWDAF 305 triggers data collection from the AF/AS 308 via the NEF 307. In particular, the NWDAF 305 sends an event subscription request (signal 3-11 to the NEF 307 and signal 3-12 from the NEF 307 to the AF/AS 308)) to the AF/AS 308 to retrieve information relating to spam/non-spam content detected at the AF/AS 308 for the UE(s) with the UE-ID(s) indicated in the analytics subscription request 3-2. The event subscription request can include any of an event identifier (e.g. Event-ID=spam), an event filter (e.g. Event-Filter=email) and one or more identifiers (e.g. UE-ID) of the UEs the request relates to. The event subscription request (signal 3-11) may be a Nnef_EventExposure_Subscribe request message, and the event subscription request (signal 3-12) may be a Naf_EventExposure_Subscribe request message.

The AF/AS 308 responds to the event subscription request message signal 3-12 with a successful response (accepting the request) (signal 3-13).

The NEF 307 responds to the request message signal 3-11 with a successful response (accepting the request) (signal 3-14).

In step 3-15, the NWDAF 305 triggers data collection from the UPF 302. In particular, the NWDAF 305 sends an event subscription request (signal 3-16 to the UPF 302) to the UPF 302 to retrieve information (flow information) relating to data traffic/content detected at the UPF 302 for the UE(s) with the UE-ID(s) indicated in the analytics subscription request 3-2. The event subscription request can include any of an event identifier (e.g. Event-ID=spam), an event filter (e.g. Event-Filter=email) and one or more identifiers (e.g. UE-ID) of the UEs the request relates to. The event subscription request (signal 3-16) may be a Nupf_EventExposure_Subscribe request message.

The UPF 302 responds to the event subscription request message signal 3-16 with a successful response (accepting the request) (signal 3-17).

Those skilled in the art will appreciate specific mechanisms that can be used by the NWDAF 305 to trigger data collection from the UPF 302. For example, existing mechanisms proposed in 3GPP TR 23.700-91 can be used (e.g. through SMF or directly, assuming a service based UPF).

In step 3-18, the NWDAF 305 triggers data collection from the UE 301. In particular, the NWDAF 305 sends an event subscription request (signal 3-19) to the UE 301 to retrieve information relating to data traffic/content for the UE(s) with the UE-ID(s) indicated in the analytics subscription request 3-2. The event subscription request can include any of an event identifier (e.g. Event-ID=OSApplications), an event filter (e.g. Event-Filter=email) and one or more identifiers (e.g. UE-ID) of the UEs the request relates to. The event subscription request (signal 3-16) may be a Nue_EventExposure_Subscribe request message.

The UE 301 responds to the event subscription request message signal 3-19 with a successful response (accepting the request) (signal 3-20).

Those skilled in the art will appreciate specific mechanisms that can be used by the NWDAF 305 to trigger data collection from the UE 301. For example, existing mechanisms proposed in 3GPP TR 23.700-91 can be used.

Steps/signals 3-21 to 3-39 relate to the collection of information about content (e.g. emails) sent between the UE 301 and the AF/AS 308, and the sending of that information to the NWDAF 305. Thus, in step 3-21 the user/UE starts an application (e.g. App-ID=example, which can be an email application). The UE 301 detects this and starts to gathers data for Event-ID=OSApplications.

Steps/signals 3-21 to 3-39 correspond respectively to steps/signals 2-15 to 2-33 and 2-34 to 2-52 of FIG. 2, except that the content sent in FIG. 3 is ‘live’ content, i.e. it is not pre-generated or prelabelled test spam content or test non-spam content. This ‘live’ content therefore does not include a Tag-ID.

Once the information is collected by the NWDAF 305, in step 3-40 the NWDAF 305 produces an analytics result/report based on the data collected from the UDR 303, the ADRF 304, the AF/AS 308, the UE 301 and UPF 302. This analytics relates to the detection of spam traffic/content. The analytics results are generated by the NWDAF 305 using the ML model trained according to method described above with respect to FIG. 2.

The analytics result/report can include any one or more of the following types of information:
Type of analytics (Analytic-Type)=(any one or more of) email, IM, SMS, MMS, etc.
An indication of a normal or abnormal scenario. In case the NWDAF 305 determines that traffic (for the requested type) corresponds to a normal (non-spam) scenario (e.g. a normal email, IM, SMS or MMS traffic) or an abnormal (spam) scenario, this can be indicated in the Analytic-Result, optionally including a confidence level in the normal/abnormal decision (e.g. a percentage from 0% to 100%).
A list of identifiers of one or more UEs (e.g. list of UE-IDs). This can identify which UE-IDs have been found with spam (e.g. on a per spam type basis). Each UE-ID might include the subscriber identifier (e.g. SUPI or IMSI), the subscriber public identifier (PUI/MSISDN) and/or device identifier (PEI/IMEI).
(Optional) indicates of a type(s) of spam detected. For example, in the case of Analytic-Type=email, the type of spam detected can be any of junk emails, emails with links to malicious sites or malicious attachments, unwanted emails from a specific site or specific individual, etc. The NWDAF 305 may be able to detect the spam type based, e.g., on the supervised ML model training process, which can result in a different ML model for each type of spam.
(Optional) a list of identifiers of applications (e.g. list of App-IDs). This can identify the App-IDs where spam traffic has been found.
(Optional) a list of Server IPs. This can identify the Server IPs where spam traffic has been found.
(Optional) spam volume (e.g. the data volume of the spam), including the percentage with respect to the total traffic volume. This can be used e.g., to determine how much spam traffic there is on a global basis, on a per UE-ID basis, and/or on a per spam type basis.
(Optional) a recommended traffic management action. For example, if the NWDAF 305 determines that spam traffic has been found and the confidence level (of it being spam) is high, the recommended action can be to block spam traffic for the suspect domains and/or Server IPs. If the NWDAF 305 determines that spam traffic has been found and the confidence level (of it being spam) is medium, the recommendation can be for traffic steering, e.g. to steer a copy of the suspect spam traffic towards an offline analytics engine. Another action can be to store as part of subscriber data in UDR 303 and/or ADRF 304, etc.

The NWDAF 305 then sends a subscription notify request (signal 3-41) to the Consumer 306 indicating the analytics result/report. This subscription notify request can be a Nnwdaf_AnalyticsSubscription_Notify request message. The subscription notify request can identify the type of analytics result being conveyed by including an analytic identifier (e.g. Analytic-ID=Spam). The subscription notify request can also include any of the types of information set out above for the analytics result/report.

The Consumer 306 responds to the subscription notify request message (signal 3-41) with a successful response (signal 3-42).

In step 3-43, based on the results of the analytics (Analytic-Result), the Consumer 306 (e.g. PCF) can apply or take an action. As noted above, the Analytic-Result may include a recommended traffic management action. In this case, the Consumer may take the recommended action, or decide to take a different action. If the Analytic-Result does not include a recommended action, or if the Consumer decides to take a different action, the action may be as follows. For example, if the NWDAF determines that spam traffic has been found and the confidence level (of it being spam) is high, the Consumer can take an action to block spam traffic for the suspect domains and/or Server IPs. If the NWDAF determines that spam traffic has been found and the confidence level (of it being spam) is medium, the Consumer can take an action to perform traffic steering, e.g. to steer a copy of the suspect spam traffic towards an offline analytics engine. Another action can be to store, as part of subscriber data in UDR and/or ADRF, subscriber data (for each UE-ID) that indicates the subscriber/device being a subscriber/device where spam has been detected, along with the corresponding spam information.

In the example illustrated in FIG. 3, the actions taken by the Consumer 306 in step 3-43 are to store in the subscriber data an indication of the UE-ID being a subscriber/device where spam has been detected, along with the corresponding spam related information.

Thus, the Consumer 306 triggers a store request message (signal 4-44) towards the ADRF 304 to store the relevant information. This store request message can be a Nadrf_Store request message. The store request message (signal 4-44) can including one or more the following types of parameter:
Identifier of the UE (e.g. UE-ID).
SpamInfo, including:
   Type of spam detected (e.g. Spam type=Email)
   Indication of abnormal scenario, and optionally a confidence level (e.g. a percentage from 0% to 100%).
(Optional) Sub-type(s) of spam detected. For example in the case of Spam type=email, the sub-types could be any of: junk emails, emails with links to malicious sites or malicious attachments, unwanted emails from a specific site or specific individual, etc.
(Optional) List of App-IDs identifying the App-IDs where spam traffic has been found.
(Optional) List of Server IPs identifying the Server IPs where spam traffic has been found.

In step 3-45 the ADRF 304 stores the information (SpamInfo) contained in the store request message in the subscriber data for the indicated UE-ID.

The ADRF 304 responds to the store request message (signal 4-44) with a successful response (Signal 4-46).

Alternatively or additionally to steps/signals 4-44 to 4-46, the Consumer 306 can send a store request message (signal 4-47) to the UDR 303 to store the relevant information for the UE(s). The store request message can be a Nudr_Store request message. The store request message 4-47 can comprise the same types of parameters/information as store request message 4-44.

In step 3-48 the UDR 303 stores the information (SpamInfo) contained in the store request message in the subscriber data for the indicated UE-ID.

The UDR 303 responds to the store request message (signal 4-47) with a successful response (Signal 4-49).

As noted above, other types of action can be triggered by the Consumer 306 based on the received AnalyticResult. These actions can include:
If the AF 308 (e.g. Gmail) is the consumer 306, it might also request the MNO (through the NEF 307) to block spam of a certain type (e.g. email).
The Spam traffic can be blocked or handled with a different QoS.
The traffic for App-ID (‘example’) can be blocked or handled with a different QoS.
The SpamInfo stored in the ADRF 304/UDR 303 can be used in subsequent sessions for the UE-ID, e.g. to continue monitoring Spam for UE-ID and if the same behaviour is found, and/or if the accumulated suspect spam volume exceeds a configured threshold, the user can be notified accordingly.

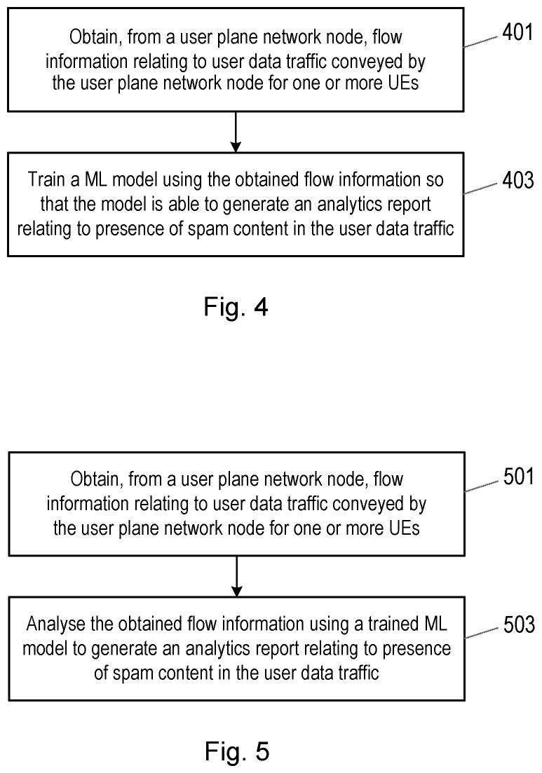

FIG. 4 is a flow chart illustrating a method performed by an analytics node (e.g. an NWDAF) in a communication network according to various embodiments. The analytics node may perform the method in response to executing suitably formulated computer readable code. The computer readable code may be embodied or stored on a computer readable medium, such as a memory chip, optical disc, or other storage medium. The computer readable medium may be part of a computer program product.

In step 401, the analytics node obtains flow information relating to user data traffic conveyed by a user plane network node in the communication network for one or more UEs. This flow information is obtained from a user plane network node in the communication network (e.g. a UPF). The flow information comprises measurements of traffic flows on a per traffic flow basis.

The user data traffic can comprise one or more types of content, such as emails, IM messages, SMS messages, and/or MMS messages.

The flow information can comprise information for a plurality of instances of content (e.g. a plurality of emails) in the user data traffic. The flow information can comprise, for a traffic flow, any one or more of: a timestamp for the traffic flow; a data volume of the traffic flow; 5-tuples for a TCP/IP connection for the traffic flow; an application or domain that the traffic flow relates to; and addresses of one or more servers that the traffic flow relates to.

In some embodiments, some or all of the user data traffic conveyed by the user plane network node, and to which the obtained flow information relates to, comprises one or more instances of spam training content. In these embodiments, the traffic flows corresponding to the one or more instances of spam training content comprise a predetermined identifier corresponding to spam training content. In some embodiments, some or all of the user data traffic conveyed by the user plane network node, and to which the obtained flow information relates to, comprises one or more instances of non-spam training content.

In step 403, the analytics node trains a ML model using the obtained flow information. The ML model is trained to generate an analytics report relating to presence of spam content in the user data traffic. Spam content is any type of content that is unsolicited and/or unwanted by the one or more UEs, and/or unsolicited and/or unwanted by one or more destinations for the user data traffic (e.g. an AF or AS). The spam content present in the user data traffic can be one or more spam emails, spam IM messages, spam SMS messages, and/or spam MMS messages.

The analytics report that the ML model is trained is generate can comprise a number of different types of information. For example the analytics report can comprise one or more of: an indication of one or more types of spam content present in the user data traffic; an indication of an amount of spam content present in the user data traffic; an indication of an amount of spam content present in the user data traffic relative to non-spam content present in the user data traffic; an indication of whether an amount of spam content present in the user data traffic is normal or abnormal; a confidence level for an amount of spam content present in the user data traffic; an indication of one or more specific UEs for which spam content has been detected; an indication of one or more user applications in the one or more UEs in which spam content has been detected; an indication of one or more servers from which spam content has been detected; and an indication of an action that can be taken in response to the spam content present in the user data traffic.

In some embodiments, the method further comprises receiving, from a consumer network node, a request for an analytics report relating to spam content. In some embodiments, the method further comprises receiving, from a consumer network node, a request for the ML model to be trained.

The method may further comprise the analytics node obtaining application information relating to one or more applications used at the UE to receive and/or send the user data traffic. This application information is obtained from one or more UEs. In these embodiments, the ML model is trained using the application information.

The method may further comprise the analytics node obtaining external application information relating to the presence of spam content in user data traffic received by an AF or AS. This external application information can be received from the AF or AS. In these embodiments, the ML model is trained using the external application information.

The method may further comprise the analytics node obtaining analytics information relating to previously-generated analytics reports relating to presence of spam content in previous user data traffic. This analytics information can be received from an analytic storage node (e.g. an ADRF). In these embodiments, the ML model is trained using the analytic information.

FIG. 5 is a flow chart illustrating another method performed by an analytics node (e.g. an NWDAF) in a communication network according to various embodiments. The analytics node may perform the method in response to executing suitably formulated computer readable code. The computer readable code may be embodied or stored on a computer readable medium, such as a memory chip, optical disc, or other storage medium. The computer readable medium may be part of a computer program product.

In step 501, the analytics node obtains flow information relating to user data traffic conveyed by a user plane network node for one or more UEs. This flow information is obtained from the user plane network node. The flow information comprises measurements of traffic flows on a per traffic flow basis.

The user data traffic can comprise one or more types of content, such as emails, IM messages, SMS messages, and/or MMS messages.

The flow information can comprise information for a plurality of instances of content (e.g. a plurality of emails) in the user data traffic. The flow information can comprise, for a traffic flow, any one or more of: a timestamp for the traffic flow; a data volume of the traffic flow; 5-tuples for a TCP/IP connection for the traffic flow; an application or domain that the traffic flow relates to; and addresses of one or more servers that the traffic flow relates to.

In step 503, the analytic node analyses the obtained flow information using a trained ML model to generate an analytics report relating to the presence of spam content in the user data traffic. Spam content is any type of content that is unsolicited and/or unwanted by the one or more UEs, and/or unsolicited and/or unwanted by one or more destinations for the user data traffic. The spam content present in the user data traffic can be one or more spam emails, spam IM messages, spam SMS messages, and/or spam MMS messages.

In some embodiments, the ML model used in step 503 has been trained according to the method described above with reference to FIG. 4.

The analytics report generated by the ML model in step 503 can comprise a number of different types of information. For example the analytics report can comprise one or more of: an indication of one or more types of spam content present in the user data traffic; an indication of an amount of spam content present in the user data traffic; an indication of an amount of spam content present in the user data traffic relative to non-spam content present in the user data traffic; an indication of whether an amount of spam content present in the user data traffic is normal or abnormal; a confidence level for an amount of spam content present in the user data traffic; an indication of one or more specific UEs for which spam content has been detected; an indication of one or more user applications in the one or more UEs in which spam content has been detected; an indication of one or more servers from which spam content has been detected; and an indication of an action that can be taken in response to the spam content present in the user data traffic.

In some embodiments, the analytics node can receive a request for an analytics report relating to spam content from a consumer network node. Receipt of this request can cause step 501 to be performed.

In some embodiments, the generated analytics report is sent to a consumer network node.

The method may further comprise the analytics node obtaining application information relating to one or more applications used at the UE to receive and/or send the user data traffic. This application information is obtained from one or more UEs. In these embodiments, the application information is analysed by the ML model to generate the analytics report.

The method may further comprise the analytics node obtaining external application information relating to the presence of spam content in user data traffic received by an AF or AS. This external application information can be received from the AF or AS. In these embodiments, the external application information is analysed by the ML model to generate the analytics report.

The method may further comprise the analytics node obtaining analytics information relating to previously-generated analytics reports relating to presence of spam content in previous user data traffic. This analytics information can be received from an analytic storage node (e.g. an ADRF). In these embodiments, the analytics information is analysed by the ML model to generate the analytics report.

In some embodiments, the analytics node sends the generated analytics report to the analytic storage node for storage.

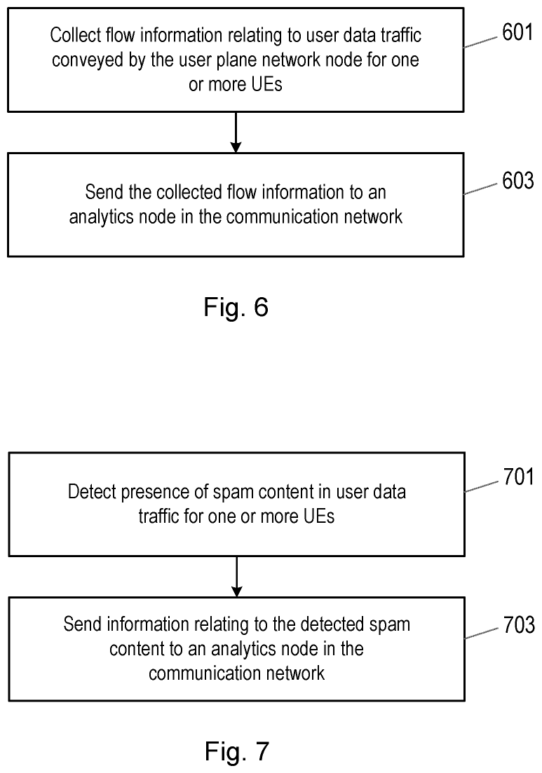

FIG. 6 is a flow chart illustrating a method performed by a user plane network node (e.g. a UPF) in a communication network according to various embodiments. The user plane network node may perform the method in response to executing suitably formulated computer readable code. The computer readable code may be embodied or stored on a computer readable medium, such as a memory chip, optical disc, or other storage medium. The computer readable medium may be part of a computer program product.

In step 601, the user plane network node collects flow information relating to user data traffic conveyed by the user plane network node for one or more UEs in the communication network. The flow information comprises information measurements of traffic flows on a per traffic flow basis. The user data traffic can comprise one or more types of content, such as emails, IM messages, SMS messages, and/or MMS messages.

The flow information can comprise information for a plurality of instances of content (e.g. a plurality of emails) in the user data traffic. The flow information can comprise, for a traffic flow, any one or more of: a timestamp for the traffic flow; a data volume of the traffic flow; 5-tuples for a TCP/IP connection for the traffic flow; an application or domain that the traffic flow relates to; and addresses of one or more servers that the traffic flow relates to.

In some embodiments, some or all of the user data traffic conveyed by the user plane network node, and to which the collected flow information relates to, comprises one or more instances of spam training content. In these embodiments, the traffic flows corresponding to the one or more instances of spam training content comprise a predetermined identifier corresponding to spam training content. In some embodiments, some or all of the user data traffic conveyed by the user plane network node, and to which the collected flow information relates to, comprises one or more instances of non-spam training content.

In step 603, the user plane network node sends the collected flow information to an analytics node (e.g. a NWDAF) in the communication network.

FIG. 7 is a flow chart illustrating a method performed by an AF or an AS in a communication network according to various embodiments. The AF or AS may perform the method in response to executing suitably formulated computer readable code. The computer readable code may be embodied or stored on a computer readable medium, such as a memory chip, optical disc, or other storage medium. The computer readable medium may be part of a computer program product.

In step 701, the AF or AS detects a presence of spam content in user data traffic for one or more UEs that operate in a communication network. The user data traffic can comprise one or more types of content, such as emails, IM messages, SMS messages, and/or MMS messages.

In some embodiments, some or all of the user data traffic comprises one or more instances of spam training content. In these embodiments, the one or more instances of spam training content can comprise a predetermined identifier corresponding to spam training content. In these embodiments, the AF or AS can detect the presence of spam content by examining the identifiers associated with the user data traffic. In some embodiments, some or all of the user data traffic comprises one or more instances of non-spam training content.

In step 703, the AF or AS sends information relating to the detected spam content to an analytics node in the communication network. This information is referred to herein as external application information.

In some embodiments, the AF or AS is requested to provide the external application information by the analytics node.

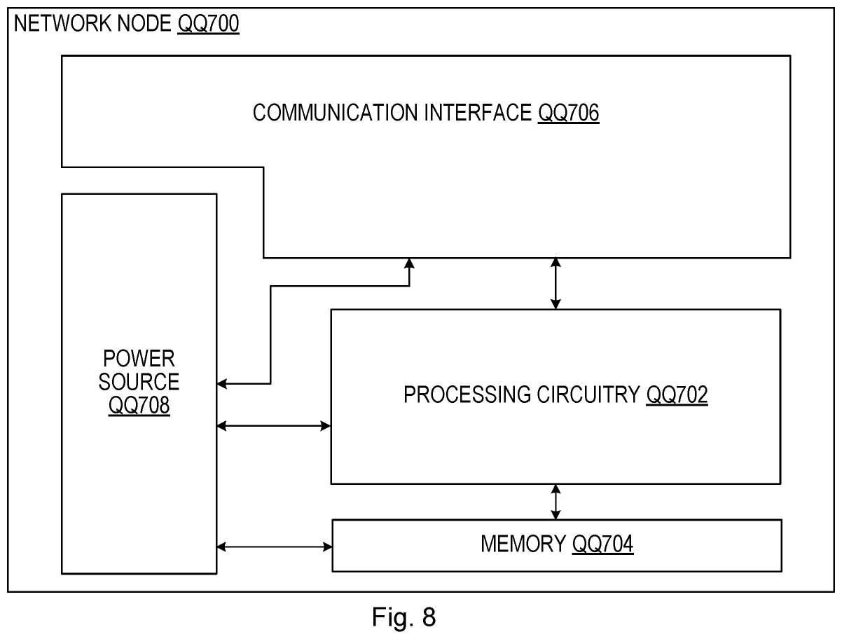

FIG. 8 shows a core network node 800 in accordance with some embodiments that can be used to implement the techniques described herein. The core network node 800 can be any of an analytics node (e.g. NWDAF), a user plane network node (e.g. a UPF), or an AS or AF.

As used herein, core network node refers to equipment capable, configured, arranged and/or operable to communicate directly or indirectly with a UE and/or with other core network nodes or equipment or RAN network nodes, in a telecommunication network. The core network node 800 may be operable as a core network node, a core network function or, more generally, a core network entity, such as the core network node QQ108 described above with respect to Figure QQ1). Examples of core network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Network Data Analytics Function (NWDAF), Security Edge Protection Proxy (SEPP), Network Exposure Function (NEF), and/or a User Plane Function (UPF).

The core network node 800 includes processing circuitry 802, a memory 804, a communication interface 806, and a power source 808, and/or any other component, or any combination thereof. The core network node 800 may be composed of multiple physically separate components, which may each have their own respective components. In certain scenarios in which the core network node 800 comprises multiple separate components, one or more of the separate components may be shared among several core network nodes.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other core network node 800 components, such as the memory 804, core network node 800 functionality. For example, the processing circuitry 802 may be configured to cause the network node to perform the methods as described with reference to any of FIGS. 2-7.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the core network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signalling and/or data between a core network node, access network node(s), and/or UE.

The power source 808 provides power to the various components of core network node 800 in a form suitable for the respective components (e.g., at a voltage and current level needed for each respective component). The power source 808 may further comprise, or be coupled to, power management circuitry to supply the components of the core network node 800 with power for performing the functionality described herein. For example, the core network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the core network node 800 may include additional components beyond those shown in FIG. 8 for providing certain aspects of the core network node's functionality, including any of the functionality described herein and/or any functionality necessary to support the subject matter described herein. For example, the core network node 800 may include user interface equipment to allow input of information into the core network node 800 and to allow output of information from the core network node 800. This may allow a user to perform diagnostic, maintenance, repair, and other administrative functions for the core network node 800.

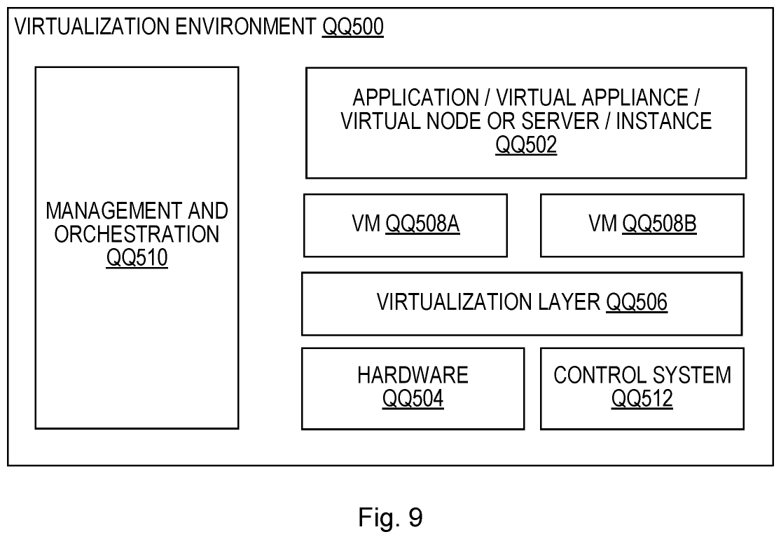

FIG. 9 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a core network node, AF or AS.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 912 which may alternatively be used for communication between hardware nodes and radio units.

Although the computing devices described herein (e.g. network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A method performed by an analytics node in a communication network, the method comprising:
obtaining, from a user plane network node in the communication network, flow information relating to user data traffic conveyed by the user plane network node for one or more user equipments (UEs) in the communication network, wherein the flow information comprises measurements of traffic flows on a per traffic flow basis; and
analysing the obtained flow information using a trained machine learning (ML) model to generate an analytics report, wherein the analytics report relates to presence of spam content in the user data traffic.

2. The method of claim 1, wherein
the user data traffic comprises one or more types of content, wherein the one or more types of content comprise any of emails, Instant Messaging (IM) messages, Short Message Service (SMS) messages, and/or Multimedia Messaging Service (MMS) messages.

3. The method of claim 2, wherein
the spam content present in the user data traffic is one or more spam emails, one or more spam IM messages, one or more spam SMS messages, and/or one or more spam MMS messages.

4. The method of claim 1, wherein
the spam content is any type of content that is unsolicited and/or unwanted by the one or more UEs, and/or unsolicited and/or unwanted by one or more destinations for the user data traffic.

5. The method of claim 1, wherein
the analytics report comprises:
an indication of one or more types of spam content present in the user data traffic;
an indication of an amount of spam content present in the user data traffic;
an indication of an amount of spam content present in the user data traffic relative to non-spam content present in the user data traffic;
an indication of whether an amount of spam content present in the user data traffic is normal or abnormal;
a confidence level for an amount of spam content present in the user data traffic;
an indication of one or more specific UEs for which spam content has been detected;
an indication of one or more user applications in the one or more UEs in which spam content has been detected;
an indication of one or more servers from which spam content has been detected; and/or
an indication of an action that can be taken in response to the spam content present in the user data traffic.

6-14. (canceled)

15. A method performed by an analytics node in a communication network, the method comprising:
obtaining, from a user plane network node in the communication network, flow information relating to user data traffic conveyed by the user plane network node for one or more user equipments (UEs) in the communication network, wherein the flow information comprises information measurements of traffic flows on a per traffic flow basis; and
training a machine learning (ML) model using the obtained flow information, wherein the ML model is trained to generate an analytics report relating to presence of spam content in the user data traffic.

16. The method of claim 15, wherein
the user data traffic comprises one or more types of content, wherein the one or more types of content comprise any of emails, Instant Messaging (IM) messages, Short Message Service (SMS) messages, and/or Multimedia Messaging Service (MMS) messages.

17. The method of claim 16, wherein
the spam content present in the user data traffic is one or more spam emails, one or more spam IM messages, one or more spam SMS messages, and/or one or more spam MMS messages.

18. The method of claim 15, wherein
the spam content is any type of content that is unsolicited and/or unwanted by the one or more UEs, and/or unsolicited and/or unwanted by one or more destinations for the user data traffic.

19. The method of claim 15, wherein
the analytics report is to comprise:
an indication of one or more types of spam content present in the user data traffic;
an indication of an amount of spam content present in the user data traffic;
an indication of an amount of spam content present in the user data traffic relative to non-spam content present in the user data traffic;
an indication of whether an amount of spam content present in the user data traffic is normal or abnormal;
a confidence level for an amount of spam content present in the user data traffic;
an indication of one or more specific UEs for which spam content has been detected;
an indication of one or more user applications in the one or more UEs in which spam content has been detected;
an indication of one or more servers from which spam content has been detected; and/or
an indication of an action that can be taken in response to the spam content present in the user data traffic.

20-30. (canceled)

31. A method of operating a user plane network node in a communication network, wherein the method comprises:
collecting flow information relating to user data traffic conveyed by the user plane network node for one or more user equipments (UEs) in the communication network, wherein the flow information comprises information measurements of traffic flows on a per traffic flow basis; and
sending the collected flow information to an analytics node in the communication network.

32. The method of claim 31, wherein
the user data traffic comprises one or more types of content, wherein the one or more types of content comprise any of emails, Instant Messaging (IM) messages, Short Message Service, (SMS) messages, and/or Multimedia Messaging Service (MMS) messages.

33. The method of claim 32, wherein
the spam content present in the user data traffic is one or more spam emails, one or more spam IM messages, one or more spam SMS messages, and/or one or more spam MMS messages.

34. The method of claim 31, wherein
the spam content is any type of content that is unsolicited and/or unwanted by the one or more UEs, and/or unsolicited and/or unwanted by one or more destinations for the user data traffic.

35. The method of claim 31, wherein
the flow information comprises information for a plurality of traffic flows in the user data traffic.

36-41. (canceled)

42. A method of operating an application function or an application server, wherein the method comprises:
detecting a presence of spam content in user data traffic for one or more user equipments (UEs) that operate in a communication network; and
sending information relating to the detected spam content to an analytics node in the communication network.

43. The method of claim 42, wherein the user data traffic comprises one or more types of content, wherein the one or more types of content comprise any of emails, Instant Messaging (IM) messages, Short Message Service, (SMS) messages, and/or Multimedia Messaging Service (MMS) messages.

44. The method of claim 43, wherein the spam content present in the user data traffic is one or more spam emails, one or more spam IM messages, one or more spam SMS messages, and/or one or more spam MMS messages.

45. The method of claim 42, wherein the spam content is any type of content that is unsolicited and/or unwanted by the one or more UEs, and/or unsolicited and/or unwanted by one or more destinations for the user data traffic.

46. The method of claim 42, wherein the method further comprises:
receiving, from the analytics node, a request for information relating to spam content detected in user data traffic;
wherein the information is sent to the analytics node in response to the request.

47-67. (canceled)
